(19) United States
(12) Patent Application Publication
(10) Pub. No.: US 2008/0275846 A1
(43) Pub. Date: Nov. 6, 2008

(54) FILTERING SEARCH RESULTS USING CONTACT LISTS

(75) Inventor: Randi-Lise Hjelmeland Almas, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/744,519

(22) Filed: May 4, 2007

(51) Int. Cl. G06F 17/30

(52) U.S. Cl. 707/3; 707/E17.001

(57) ABSTRACT

A device may obtain a search result from a search engine, select a contact in a contact list, filter the search result based on browsing information of the selected contact, and display the filtered search result.

### TECHNICAL FIELD OF THE INVENTION

Implementations described herein relate to search, and in particular, to filtering search results based on information about uses of browsers by people in a contact list.

### DESCRIPTION OF RELATED ART

Many Internet search engines provide a list of web resources (e.g., web pages, videos, images, sound, etc.) and assign a corresponding ranking value to each resource. Each ranking value may indicate the relative importance that the search engine assigns to the web resource.

### SUMMARY

According to one aspect, a method may comprise obtaining a search result from a search engine, selecting a contact in a contact list, filtering the search result based on browsing information of the selected contact, and displaying the filtered search result.

Additionally, filtering the search result based on browsing information may include eliminating from the search result one or more addresses of web resources that do not match addresses of web resources in the browsing information.

Additionally, the method may further comprise obtaining browsing information associated with the contacts from a remote device.

Additionally, the method may further comprise collecting browsing information about a user of a client device, and sending the browsing information about the user to a remote device.

Additionally, the method may further comprise filtering the search research based on a descendent of the contact list.

According another aspect, a method may comprise receiving selected contacts and search terms from a client device, performing a search based on the search terms to obtain a list of web resources, filtering the list of web resources based on browsing information associated with the selected contacts, and sending the filtered list of web resources to the client device.

Additionally, performing a search may include requesting a search engine to perform the search, and receiving the list of web resources from the search engine.

Additionally, the method may further comprise requesting part of the browsing information from other devices when the part of the browsing information is not locally available to the client device.

Additionally, filtering the list of web resources may include finding addresses of web resources that are included in both the browsing information and the search result.

According to yet another aspect, a device may comprise a browser and a processor. The processor may be configured to accept a search request from a user, operate the browser to obtain a search result from a remote device, receive contacts from the user, filter the search result based on browsing information of the selected contacts, and display the filtered search result.

Additionally, the device may further comprise a client program implemented as an add-on toolbar or a stand-alone program, the client program receiving the contacts from the user.

Additionally, the device may further comprise a contact list that includes the selected contacts.

Additionally, the remote device may include a search engine.

Additionally, the processor may be further configured to download and install the client program.

Additionally, the processor may be further configured to collect browsing information of a user of the device.

Additionally, the processor may be further configured to send the browsing information of the user to a remote device.

Additionally, the processor may be further configured to receive the browsing information about the selected contacts.

Additionally, the search request may include search terms.

According yet another aspect, a device may comprise a processor configured to receive a search request and a list of contacts from a first remote device, send the search request to a second remote device, receive a search result from a second remote device, filter the search result based on browsing information of the contacts, and send the filtered search result to the first remote device.

According to a further aspect, a device may comprise means for obtaining a search result from a search engine on behalf of a user, means for filtering the search result based on browsing history information associated with contacts of the user, and means for displaying the filtered search result.

### BRIEF DESCRIPTION OF THE DRAWINGS

The accompanying drawings, which are incorporated in and constitute a part of this specification, illustrate one or more embodiments described herein and, together with the description, explain the embodiments. In the drawings,

FIG. 1 shows a system in which concepts described herein may be implemented;

FIG. 2 is an exemplary diagram of one of the devices of FIG. 1;

FIG. 3 is an exemplary block diagram of the device of FIG. 2;

FIG. 4 is an exemplary functional block diagram of exemplary components that may be included in one of the client devices of FIG. 1;

FIG. 5 illustrates a client list filter (CLF) table in the database of FIG. 4;

FIG. 6 is an exemplary functional block diagram of exemplary components that may be included in a server device of FIG. 1;

FIG. 7 is a flowchart of an exemplary process for initiating a search and/or collecting browsing information about a user;

FIG. 8 is a flow chart of an exemplary process for performing a search and filtering the search result based on browsing information related to a contact list;

FIG. 9A is a diagram of a CLF browser plug-in as an add-on toolbar and part of a browser frame to which the add-on toolbar may be attached;

FIG. 9B is a diagram showing a pop-up menu for selecting contacts in the contact list and browsing;

FIG. 10 is an illustration of an alternative implementation of an exemplary process for performing a search and filtering the search result based on browsing information; and

FIG. 11 is a flowchart of a process for performing a search and filtering the search result at a server.

### DETAILED DESCRIPTION OF EMBODIMENTS

The following detailed description refers to the accompanying drawings. The same reference numbers in different drawings may identify the same or similar elements.

The term “browser,” as used herein, may refer to a software application that allows a user to interact with web resources at websites or hosts.

The term “child contact list” may refer to a contact list that may belong to a contact in a parent contact list. Each child contact list may include contacts, each of which may have its own contact list. Consequently, each child contact list may also be a parent contact list. A contact in a contact list that can be traced from an original contact list through one or more pairs of parent-child contact lists may be referred to as a descendent. The term “browsing information,” as used herein, may refer to information about the use of browsers, such as a history of web resources that have been visited (e.g., websites or web documents), a list of favorite web resources, latest online purchases, and a list of newsfeeds.

The term, “browsing information” of, about, or related to a contact list may include not only the browsing information of each contact in the contact list, but also the browsing information of the descendants of the contact list.

The term “search engine” as used herein may refer to a system for finding information in a network or in a computing system. The search engine may accept search terms (e.g., text, images, and/or sounds) and return a “search result” (i.e., a list of items that match the search terms). In many contexts, a “search” may entail inputting the search terms at a browser that may send the terms to the search engine over a network.

### Overview

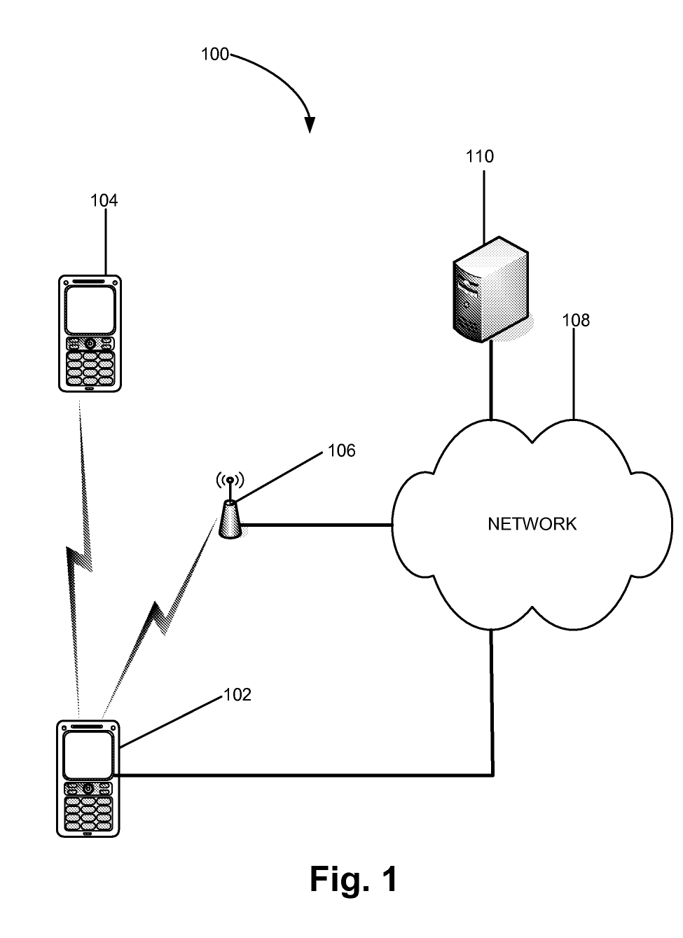

In implementations described herein, search results may be filtered and/or ranked based on browsing information related to people in a contact list. FIG. 1 shows an exemplary system that includes one implementation of concepts described herein. As shown, system 100 may include client devices 102 and 104, a wireless access point (WAP) 106, a network 108 and a server device 110. In other implementations, system 100 may include more, fewer, or different components. Moreover, one or more components of system 100 may perform one or more functions of another component of system 100.

Client device 102 may include any of the following devices: a personal computer; a telephone, such as a radio telephone; a personal communications system (PCS) terminal that may combine cellular radiotelephone with data processing, facsimile, and/or data communications capabilities; a mobile telephone; an electronic notepad; a laptop; a personal computer (PC); a personal digital assistant (PDA) that can include a radiotelephone, pager, Internet/intranet access, web browser, organizer, calendar, global positioning system (GPS) receiver; or another type of computation or communication device, a thread or process running on one of these devices, and/or an object executable by one of these devices. Client device 104 may include similar components as client device 104 and may operate similarly as client device 102.

WAP 106 may include a device for accessing network 108, such as a router that is able to receive and transmit wireless and/or wired signals, or any other device that provides access to a network. WAP 106 may communicate with client device 102 using any wireless communication protocol. Client devices 102/104 may connect to network 108 via WAP 106. In other implementations, client devices 102/104 may connect to network 108 via wired and/or wireless connections.

Network 108 may include the Internet, an ad hoc network, a local area network (LAN), a wide area network (WAN), a metropolitan area network (MAN), a cellular network, a public switched telephone network (PSTN), any other network, or combinations of networks.

Server device 110 may include one or more computer systems for hosting server programs and/or applications. Server device 110 may receive a request for uploading or downloading applications/data from client applications that may be hosted by client device 102 or 104, process the request, and transmit or receive data to and from client device 102 or 104.

In FIG. 1, client device 102 may periodically or occasionally collect browsing information of contacts and/or descendents of its contact list. The browsing information may include, for each contacts and/or descendents of the contact list, a history of web sites that have been visited and lists of favorite web sites, of latest purchases, and/or of news feeds. The information may be stored locally at client device 102 and/or may be stored remotely at server device 110.

In FIG. 1, client device 102 may make a search request through a client application (e.g., a browser) on client device 102. The request may include search terms, (e.g., text, audio and/or images) that may be used as a search criteria at a search engine (not shown) in network 108. Client device 102 may filter the result of the search based on the browsing information of selected contacts and/or descendents in the contact list in client device 102. The filtered result may be presented to the user of client device 102.

In an alternative embodiment, the search request and a list of the selected people may be sent through WAP 106 and/or network 108 to server device 110. The server device may perform a search based on the request, filter the search result based on browsing information relating to the contacts and/or descendents of the last, and relay the filtered search result to client device 102. The filtered search result may be presented to the user of client device 102.

In both of the above embodiments, if the browsing information relating to a contact in the list is not available, client device 102 and server device 110 may attempt to contact a client device of the person to obtain the information (e.g., client device 104).

### Exemplary Device

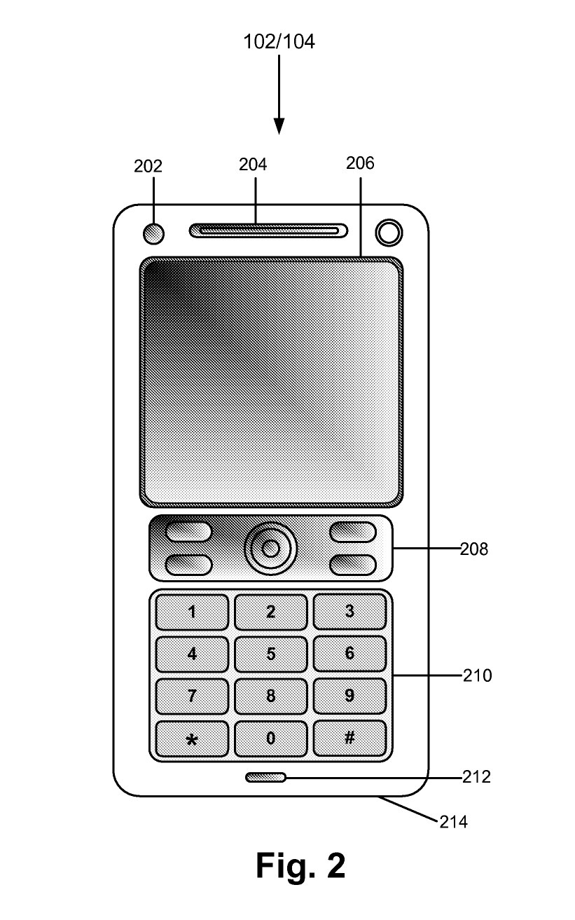

FIG. 2 is an exemplary block diagram of client device 102. As illustrated, client device 102 may include a camera 202, a speaker 204, a display 206, control buttons 208, a keypad 210, a microphone 212, and a housing 214. Camera 202 may enable a user to view, capture and store media (e.g., images, video clips) of a subject in front of device 102. Speaker 204 may provide audible information to a user of client device 102. Display 206 may include a display screen to provide visual information to the user, such as video images or pictures, and may include a touch screen (e.g., a capacitive screen, near field screen) to accept inputs from a user. Control buttons 208 may permit the user to interact with client device 102 to cause client device 102 to perform one or more operations, such as place or receive a telephone call. Keypad 210 may include a standard telephone keypad. Microphone 212 may receive audible information from the user. Housing 214 may provide a casing for components of client device 102 and may protect the components from outside elements. Client device 104 may include similar components as client device 102 and may operate similarly.

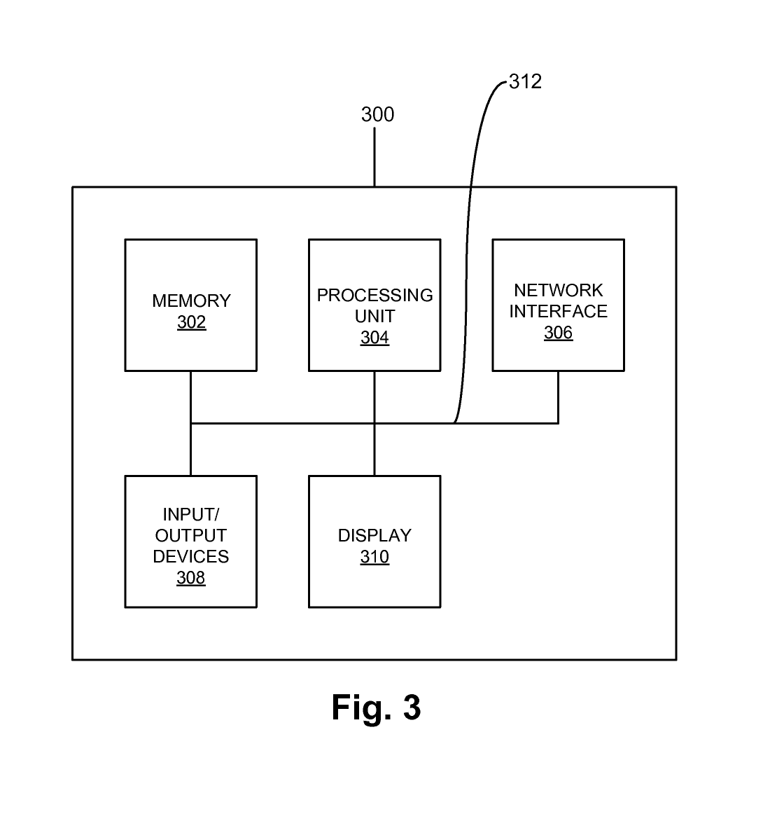

FIG. 3 shows an exemplary block diagram of a device 300. Device 300 may represent client device 102, client device 104, or server device 110. As shown, device 300 may include memory 302, a processing unit 304, a network interface 306, input/output devices 308, a display 310, and a bus 312. Depending on the implementation, device 300 may include additional, fewer, or different components. For example, if device 300 represents client device 102 or 104, device 300 may include a keypad. In another example, if device 300 represents server device 110, device 300 may include multiple central processors.

Memory 302 may include static memory, such as read only memory (ROM), and/or dynamic memory, such as random access memory (RAM), or onboard cache, for storing data and machine-readable instructions. Memory 302 may also include storage devices, such as a floppy disk, CD ROM, CD read/write (R/W) disc, and/or flash memory, as well as other types of storage devices. Processing unit 304 may include one or more processors, microprocessors, and/or processing logic capable of controlling device 300.

Network interface 306 may include any transceiver-like mechanism that enables device 300 to communicate with other devices and/or systems. For example, network interface 306 may include mechanisms for communicating via a network, such as the Internet, a terrestrial wireless network (e.g., wireless local area network (WLAN)), a satellite-based network, etc. Additionally or alternatively, network interface 306 may include a modem, an Ethernet interface to a local area network (LAN), and/or an interface/connection for connecting device 300 to other devices (e.g., a Bluetooth interface). Further, network interface 306 may include receivers, such as a Global Positioning System (GPS) receiver.

Input/output devices 308 may include a keyboard, a keypad (e.g., keypad 210 of FIG. 2), a button (e.g., control buttons 208), a mouse, a speaker (e.g., speaker 204), a microphone (e.g., microphone 212), a Digital Video Disk (DVD) writer, a DVD reader, Universal Serial Bus (USB) lines, and/or other types of devices for converting physical events or phenomena to and/or from digital signals that pertain to device 300.

Display 310 may include a device that can display signals generated by device 300 as text or images on a screen (e.g., a liquid crystal display (LCD), cathode ray tube (CRT) display, organic light-emitting diode (OLED) display, surface-conduction eletro-emitter display (SED), plasma display, field emission display (FED), bistable display, etc.) and a touch screen or a panel-enabled display that may function as a user input interface. For example, display 310 may include a pressure-sensitive (e.g., resistive), near field-sensitive (e.g., capacitive), acoustically-sensitive (e.g., surface acoustic wave), photo-sensitive (e.g., infra-red), and/or any other type of display overlay that allows display 310 to be used as an input device.

Bus 312 may provide an interface through which components of device 300 can communicate with one another.

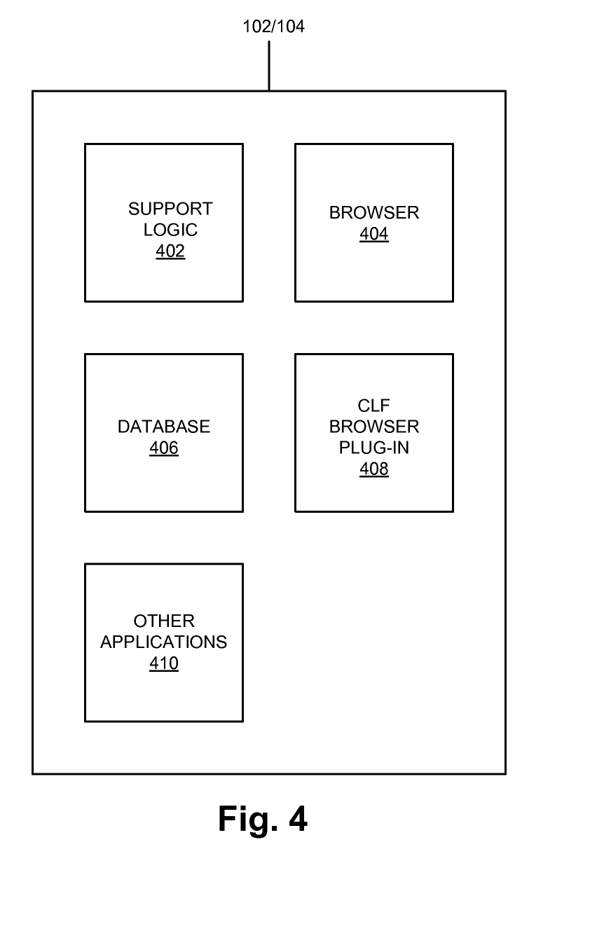

FIG. 4 is an exemplary functional block diagram of exemplary components that may be included in client device 102. As shown, client device 102 may include support logic 402, a browser 404, a database 406, contact-list-filter (CLF) browser plug-in 408, and/or other applications 410. In other implementations, client device 102 may include fewer, additional, or different types of components than those illustrated in FIG. 4.

Support logic 402 may include hardware and/or software for performing various support functions for other components in FIG. 4 (e.g., browser 404, CLF browser plug-in 408, other applications 410). For example, support logic 402 may provide interfaces between the components illustrated in FIG. 4 (e.g., other applications 410) and the components in FIG. 3 (e.g., network interface 306, input/output devices 308, and display 310). In yet another example, support logic 402 may provide a TCI/IP stack to support communication applications, such as browser 404.

Browser 404 may include a software application that allows a user to interact with web resources at websites or hosts. A user may use browser 404 to submit search queries to search engines in network 108 (FIG. 1) and/or server device 110 and to view search results that are received at client device 102 from the search engines and/or server device 110.

Database 406 may act as an information repository for CLF browser plug-in 408 and/or other applications 410. For example, CLF browser plug-in 408 may retrieve and/or store a contact list, or information about the contact list to/from database 406. In another example, other applications 410 may store and/or retrieve email, text, and/or sounds to and in/from database 406.

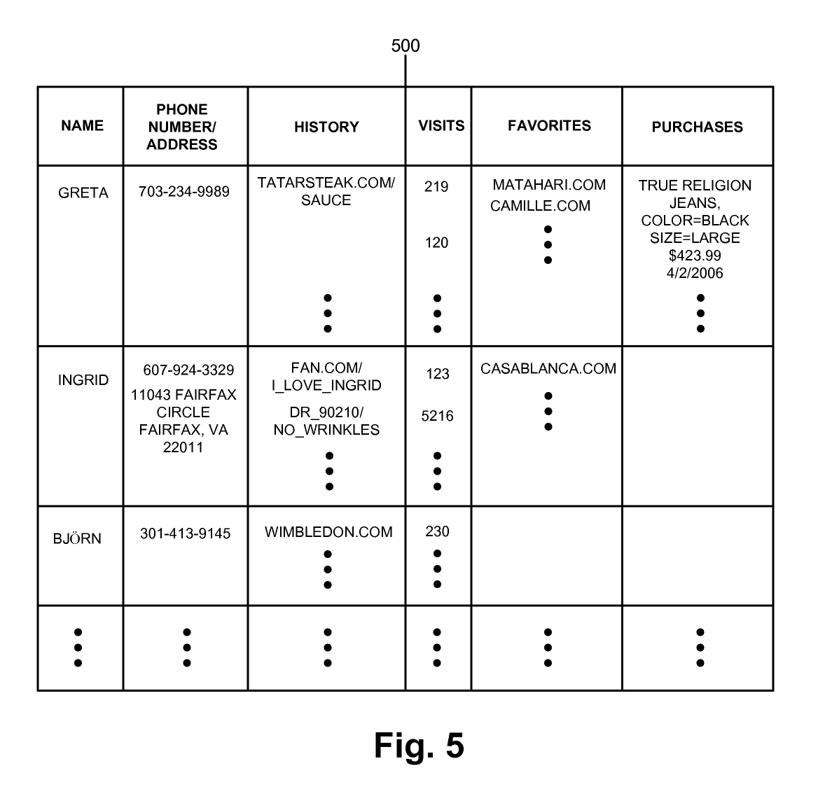

Depending on implementation, database 406 may include a contact list and browsing information related to the contact list. In one implementation, the contact list and the browsing information may be arranged in a CLF table, as illustrated in FIG. 5. As shown in this example, a CLF table 500 may include, for each contact, a name field, phone number/address field, a history field, a visits field, a favorites field, and a purchases field. The name field and phone number/address field may include the name, the phone number and the address of a contact. The history field may include a list of web resources that the contact has visited. The visits field may include a list of numbers, where each number represents a number of times the contact has visited a web resource listed in the history field. The favorites field may include a list of favorite web resources of the contact. The purchases field may include a list of purchases by the contact. In different implementations, CLF table 500 may include additional, fewer, or different fields and information than those illustrated in FIG. 5. For example, CLF table 500 may include a field that provides a list of web resources that are created by each contact. Such web resources may reside on a client device or on a server.

Returning to FIG. 4, CLF browser plug-in 408 may include a software application that attaches itself to browser 404 at browser startup and may operate in conjunction with browser 404. CLF browser plug-in 408 may provide browsing information about a user at client device 102 to other devices in network 108 (FIG. 1), may obtain browsing information about people in a contact list from other devices in network 108, and/or may filter search results based on the obtained browsing information. In some implementations, CLF browser plug-in 408 may be directly integrated in browser 404.

More specifically, if client device 102 performs a browsing operation (e.g., visit a website or purchase an item at an online store), CLF browser plug-in 408 may update browsing information of the user in database 406. In addition, the browsing information may be sent to a trusted device, periodically or based on demand from the trusted device. If a client device 102 submits a search request to a search engine through browser 404, the search results that are provided by the search engine may be filtered by CLF browser plug-in 408 based on browsing information related to the contact list. If the browsing information is not in database 406, CLF browser plug-in 408 may attempt to obtain the browsing information from a server or from client devices of the members.

Other applications 410 may include hardware and/or software for supporting various functionalities of client device 102, such as text messaging, email, Multimedia Messaging, wireless communications (e.g., Bluetooth), image capturing and storing, infrared communications, web access, file uploading and downloading, image transfer, etc.

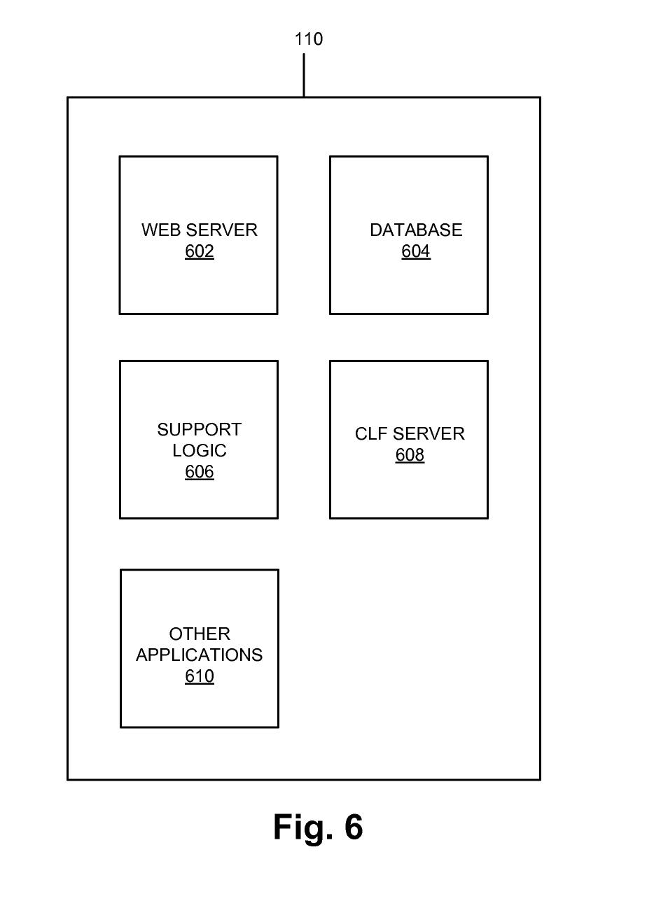

FIG. 6 is an exemplary functional block diagram of exemplary components that may be included in server device 110. As shown, server device 110 may include web server 602, database 604, support logic 606, CLF server 608, and other applications 610. In other implementations, server device 110 may include fewer, additional, or different components than the ones shown in FIG. 6.

Web server 602 may include hardware and/or software for accepting hypertext transfer protocol (HTTP) messages and other protocol (e.g., file transfer protocol (FTP),secure HTTP (HTTPS)) messages and for providing responses to the messages (e.g., web documents, videos, images, sounds, etc.). For example, in response to a search request from CLF browser plug-in 408 (FIG. 4) in client device 102, web server 602 may perform a search on behalf of CLF browser plug-in 408 and may send the result of the search to client device 102.

Database 604 may act as an information repository for web server 602, CLF server 608, and/or other applications 610. For example, web server 602 may retrieve and store information in database 604 and may present the information as web pages to client devices. In another example, CLF server 608 may store and/or retrieve browsing information related to the contact lists of client devices 102/104.

Depending on the implementation, database 604 may include contact lists and browsing information related to the contact lists. The contact lists and the browsing information may have been received from many client devices. In one implementation, the contact list and the browsing information may be arranged in a CLF table, as already described above and as illustrated in FIG. 5.

Support logic 606 may include hardware and/or software for performing various support functions for other components in FIG. 6 (e.g., web server 602, CLF server 608, or other applications 610). For example, support logic 606 may provide interfaces between the components illustrated in FIG. 6 (e.g., other applications 610) and the components in FIG. 3 (e.g., network interface 306). In yet another example, support logic 606 may provide a TCP/IP stack to support communication applications, such as web server 602.

CLF server 608 may include hardware and/or software for interacting with browser 404, CLF browser plug-in 408 over network 108. CLF server 608 may receive information about a user at a client device 102 via CLF browser plug-in 408, and store the information in database 604, may dispense browsing information about different contacts in database 604, and may perform a search on behalf of a client device and transmit the search result to the client device. In one implementation, CLF server 608 may filter the search result based on the browsing information prior to sending the search result to the client device. If the browsing information is not available in database 604, CLF server 608 may attempt to contact various client devices at which the browsing information may reside.

In addition, CLF server 608 may transmit a copy of CLF browser plug-in 408 to client device 102 when CLF server 608 is notified by client device 102 that browser CLF plug-in 408 needs to be updated or installed with the latest version.

Other applications 610 may include hardware and/or software for supporting various functionalities of server device 110, such as text messaging server functions, email server functions, FTP server functions, etc.

### Exemplary Process for Filtering Search Results Using a Contact List

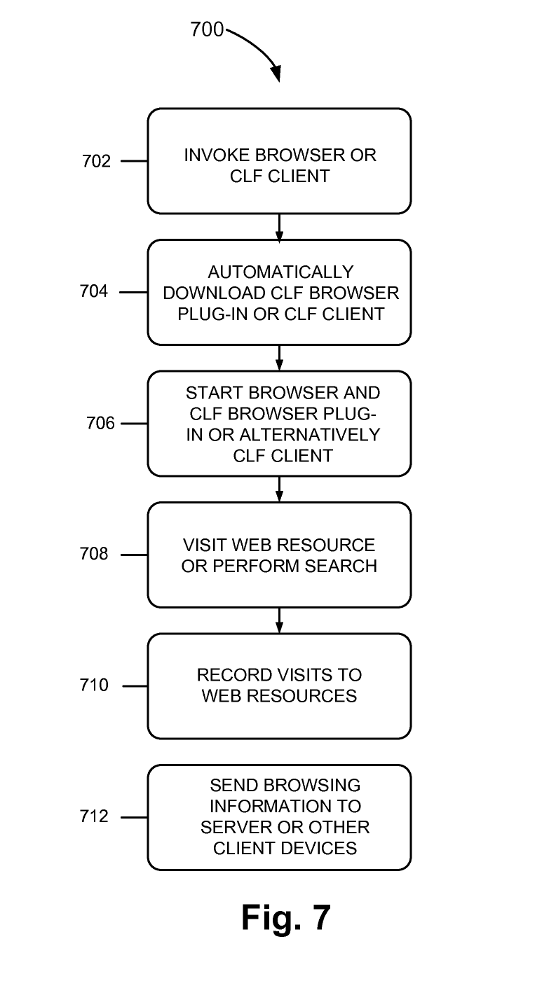

FIGS. 7-8 and 10-11 show flowcharts of exemplary processes that are associated with filtering search results using a contact list. FIG. 7 shows a flowchart of an exemplary process for initiating a search and/or collecting browsing information about a first user. The collected browsing information may be used for filtering search results by others users whose contact lists include the first user.

Process 700 may start at block 702, where browser 404 may be invoked. Browser 404 can be invoked through different mechanisms, such as a short cut, a link, or through a command-line window.

At block 706, browser 404 and CLF browser plug-in 408 may be started.

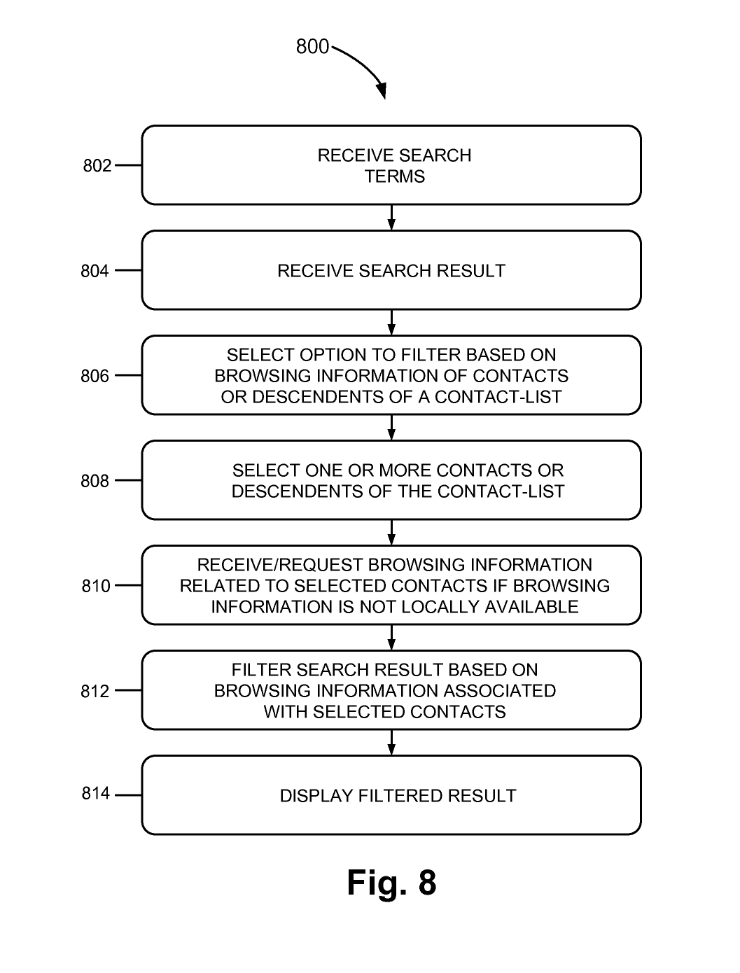

At block 708, a search may be performed or a web resource may be visited. A process for performing the search is described below, with reference to FIG. 8. If the search is performed, process 700 may terminate after block 708. Web resources that are visited may be recorded. For example, CLF browser plug-in 408 may detect the visit and record the address of the web resource (e.g., Uniform Resource Locator (URL), Uniform Resource Identifier (URI), Internet Protocol (IP) address) (block 710). The address may be recorded in a buffer, memory, and/or CLF table 500 in database 406, as part of browsing information related to the user.

At block 712, the browsing information related to the user may be sent to a server or other client devices. The browsing information may be sent based on a demand from the server or other client devices, or alternatively, based on a predetermined event at the client device (e.g., an update to CLF table 500). A device that receives the browsing information may use the information for filtering searches.

FIG. 8 shows a flow chart of an exemplary process for performing a search and filtering the search result based on browsing information related to a contact list. Process 800 may start at block 802, where search terms from a user may be received. The search terms may be sent to a search engine's web page via browser 404. Based on the search terms, the search engine receives the terms, the search engine may perform a search, obtain a search result, and send the search result to client device 102.

At block 804, browser 404 in client device 102 may receive the search result. The search result may include a list of URLs or URIs that are ranked in accordance with a specific ranking system used by the search engine.

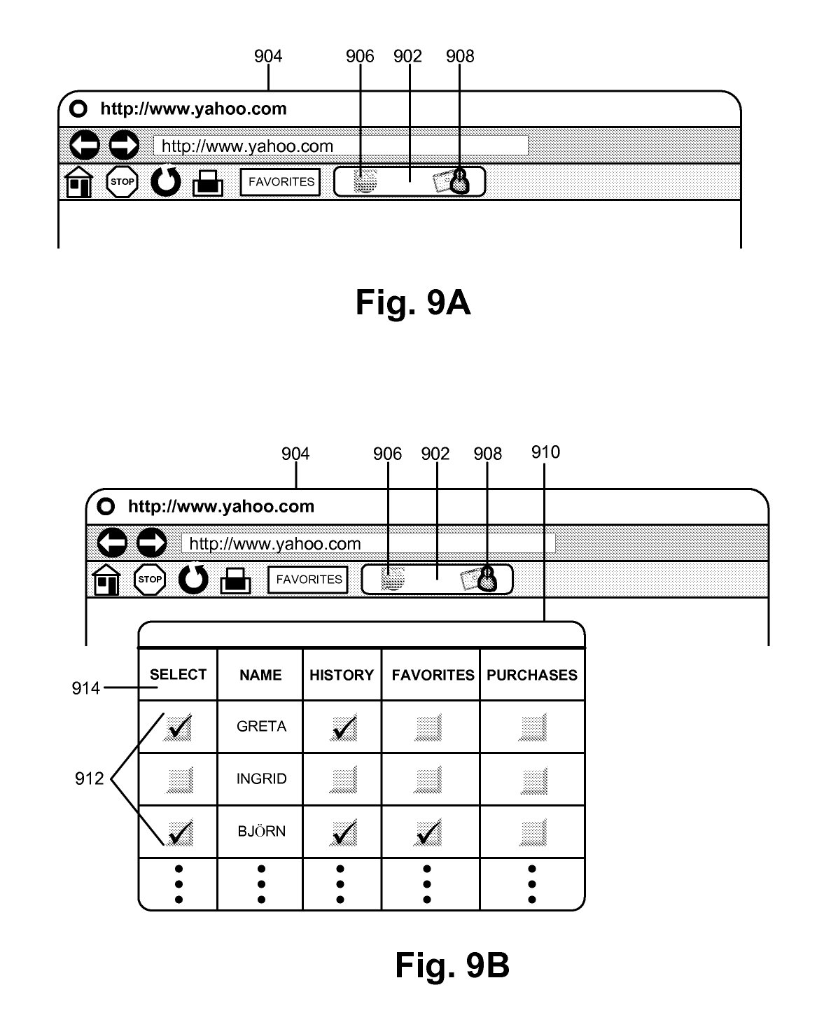

At block 806, an option to filter the search result based on browsing information of contacts or descendents of a contact list may be selected. In one implementation, the option may be available through CLF browser plug-in 408. As an example, FIG. 9A shows CLF browser plug-in 408 as an add-on toolbar 902 and part of browser frame 904 to which add-on toolbar 902 may be attached. On add-on toolbar 902, the option may be selected by activating filter button 906 via input/output devices 306 (FIG. 3) (e.g., a mouse click or a keypad).

At block 808, one or more contacts in or descendents of the contact list may be selected. In many implementations, the contacts may be selected through a menu. For example, activating edit-contacts button 908 in FIG. 9A may bring up a pop-up menu 910, as illustrated in FIG. 9B. As further shown in FIG. 9B, a contact in the contact list may be selected by activating one of checkmark boxes 912 in pop-up menu 910 under SELECT column 914. If a user prefers a specific set of browsing information to be used for filtering the search, the user may indicate the preference by activating checkmark boxes 912. Once the selection is complete, pop-up menu 910 may be closed through different components on pop-up menu 910, including a close-window button (not shown). In different implementations, the option may allow the browsing information of the contacts in the descendents of the contact list to be selected.

Returning to FIG. 8, at block 810, browsing information related to the selected contacts may be requested and/or received if the browsing information is not locally available. The browsing information may be requested and/or received in one of several ways. In one example, if a user activates the option to filter and the browsing information is not available, CLF browser plug-in 408 may make a request to a known repository for the browsing information (e.g., server 110) and receive the browsing information from the repository.

At block 812, the search result may be filtered based on the browsing information associated with the selected contacts. Depending on the implementation, there may be many ways to filter the search result. For example, if contacts and associated browsing information are selected as shown in FIG. 9B, a list of addresses in the search result (e.g., URLs and URIs) and those in the browsing information may be compared. In one implementation, any address that is in the search result may be saved for later presentation to a user under the following conditions: (1) the address is one of the addresses in the browsing information; (2) the address is referenced by a site that is listed in the browsing information; (3) the address is of a site or a web resource that references one or more of URLs or URIs that are listed in the browsing information.

At block 814, the filtered information (i.e., the information that is cached for presentation) may be displayed to the user.

### Alternative Implementation

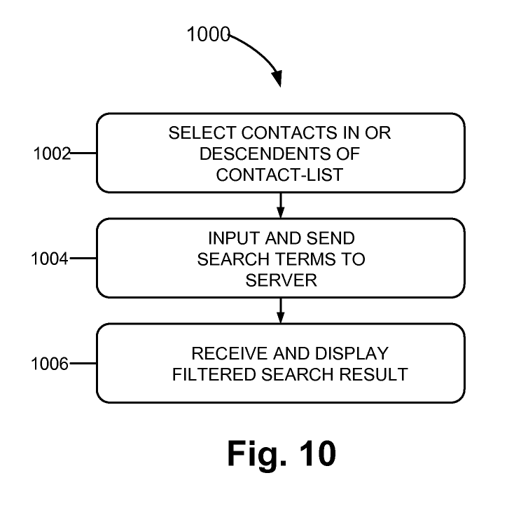

FIG. 10 illustrates an alternative implementation of an exemplary process 1000 for performing a search and filtering the search result based on browsing information related to a contact list. In process 1000, searching and filtering the search result are performed at a server (e.g., CLF server 608). CLF server 608 may reside in a remote device (e.g., server device 110).

Process 1000 may start at block 1002, where contacts or descendents of a contact list may be selected. Contacts may be selected in a manner similar to that for block 808.

At block 1004, search terms may be input and sent to a server (e.g., server 110). In one implementation, the search terms may be input via a web page presented by the server via browser 404. In many implementations, a list of the selected contacts and the associated browsing information may be sent to the server along with the search terms. In other implementations, if the browsing information associated with the selected contacts is available at the server, the list of the contacts may be sent to the server without the browsing information. If the server receives the terms and the list of selected contacts, the server may perform a search and filter the search result.

At block 1006, the filtered search result may be received from the server and displayed.

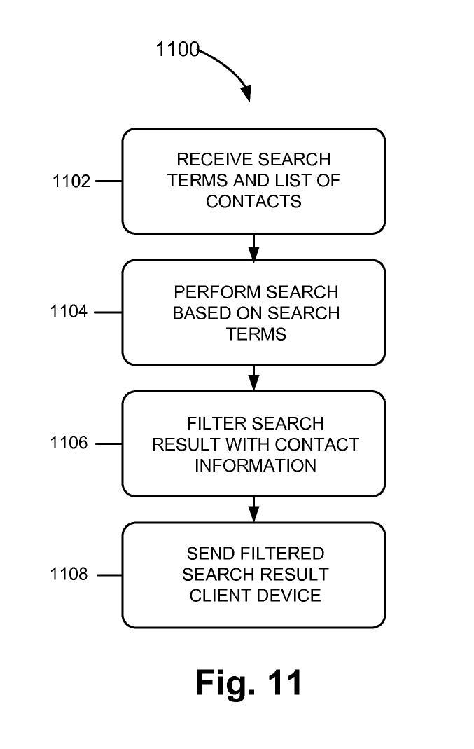

FIG. 11 shows an exemplary process for performing a search and filtering the search result at a server device. At block 1102, search terms and a list of contacts may be received. The search terms and the list may have been sent from a client device.

At bock 1104, a search may be performed based on the search terms. In one implementation, the search may be performed by looking up a database of indexed information. In another implementation, the search may be performed by using a search engine. For example, server 110 may send the search terms to a search engine on network 108.

At block 1106, the search result may be filtered based on the selected contacts. The search result may be filtered in a manner similar to that described for block 808.

At block 1108, the filtered search result may be sent to a client device.

### EXAMPLE

The following example illustrates processes involved in filtering search results using a contact list, with reference to FIGS. 1, 2, 5, and 9. The example is consistent with the exemplary process described above with reference to FIG. 8.

In the example, assume that a user of client device 102, Jane, has decided to invite Greta and Björn to her house for a dinner and that Jane is searching online for an appropriate dinner recipe. In addition, assume that a browser that Jane uses is implemented as illustrated in FIG. 9A and CLF browser tool bar 408 is implemented as an add-on toolbar 902. Further, assume that Jane's client device 102 includes a CLF table 500 shown in FIG. 5.

Jane inputs the terms “recipe” and “steak” into a web page for a search engine and obtains a result of the search. The search result includes a URL “TartarSteak.com.” Jane decides to filter the search result based on two of Jane's friends, Greta and Björm, who have similar taste in food as Jane. Jane uses a keypad 210 to activate edit-contacts button 908 in FIG. 9 and obtains a pop-up menu 910. Jane activates appropriate checkmark boxes 912 in pop-up menu 910 to indicate that she wishes to filter the search result based on Greta and Björn in her contact list. In addition she activates the checkmark boxes under HISTORY column for Greta and Björm and activates the checkmark box under FAVORITES for Greta. The checkmark boxes under HISTORY and FAVORITES indicate that the history of web resources visited by Greta and Björn and the favorite web resources of Björn may be used for filtering the search result.

Jane closes pop-up menu 910 and activates filter button 906 to filter the search result. CLF browser plug-in 408 compares the search result and the lists of URLs under HISTORY column and FAVORITES column of CLF table 500 for Greta and Bjorn (FIG. 5). Because CLF browser plug-in 408 finds “TARTARSTEAK.COM/SAUCE,” a URL of a web resource under HISTORY column in for Greta, URL “TartarSteak.com” in the search result is cached. Other URLs or URIs in the search result do not match any of the web resources that are listed in CLF table 500, and therefore, are discarded.

CLF browser plug-in 408 presents “TartarSteak.com” as the result of filtering the search result to Jane. Jane uses the URL “TartarSteak.com” to visit a website about tartar steaks and learn how to prepare them for her guests.

### CONCLUSION

The foregoing description of embodiments provides illustration, but is not intended to be exhaustive or to limit the embodiments to the precise form disclosed. Modifications and variations are possible in light of the above teachings or may be acquired from practice of the teachings.

For example, CLF browser plug-in 408 may include a capability to search devices of contacts in a contact list. In such instances, each client device 102 that is searched may send the result of the search to CLF browser plug-in 408 that requested the search. When CLF browser plug-in 408 receives all the search results, they may be aggregated and presented to the user.

In yet another example, while series of blocks have been described with regard to processes illustrated in FIGS. 7, 8, 10, and 11, the order of the blocks may be modified. For example, if CLF browser plug-in 408 up-to-date on client device 102, block 704 may be performed after blocks 706-712. If a search is performed at block 708, blocks 710 and 712 may be omitted. In FIG. 8, block 808 may be omitted if the contacts have been selected in a previous filtering operation. Furthermore, non-dependent blocks in FIGS. 7, 8, 10, and 100 may represent acts that can be performed in parallel to other blocks.

It will be apparent that aspects described herein may be implemented in many different forms of software, firmware, and hardware in the implementations illustrated in the figures. The actual software code or specialized control hardware used to implement aspects should not be construed as limiting. Thus, the operation and behavior of the aspects were described without reference to the specific software code—it being understood that software and control hardware can be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the invention have been described as “logic” that performs one or more functions. This logic may include hardware, such as a processor, an application specific integrated circuit, or a field programmable gate array, software, or a combination of hardware and software.

What is claimed is:

1. A method comprising:
obtaining a search result from a search engine;
selecting a contact in a contact list;
filtering the search result based on browsing information of the selected contact; and
displaying the filtered search result.

2. The method of claim 1, wherein filtering the search result based on browsing information includes:
eliminating from the search result one or more addresses of web resources that do not match addresses of web resources in the browsing information.

3. The method of claim 1, further comprising:
obtaining browsing information associated with the contacts from a remote device.

4. The method of claim 1, further comprising;
collecting browsing information about a user of a client device; and
sending the browsing information about the user to a remote device.

5. The method of claim 1, further comprising:
filtering the search research based on a descendent of the contact list.

6. A method comprising:
receiving selected contacts and search terms from a client device;
performing a search based on the search terms to obtain a list of web resources;
filtering the list of web resources based on browsing information associated with the selected contacts; and
sending the filtered list of web resources to the client device.

7. The method of claim 6, wherein performing a search includes:
requesting a search engine to perform the search; and
receiving the list of web resources from the search engine.

8. The method of claim 6, further comprising:
requesting part of the browsing information from other devices when the part of the browsing information is not locally available to the client device.

9. The method of claim 6, wherein filtering the list of web resources includes:
finding addresses of web resources that are included in both the browsing information and the search result.

10. A device comprising:
a browser; and
a processor configured to:
accept a search request from a user;
operate the browser to obtain a search result from a remote device;
receive contacts from the user;
filter the search result based on browsing information of the selected contacts; and
display the filtered search result.

11. The device of claim 10, further comprising a client program implemented as an add-on toolbar or a stand-alone program, the client program receiving the contacts from the user.

12. The device of claim 10, further comprising:
a contact list that includes the selected contacts.

13. The device of claim 10, wherein the remote device includes:
a search engine.

14. The device of claim 10, wherein the processor is further configured to:
download and install the client program.

15. The device of claim 10, wherein the processor is further configured to:
collect browsing information of a user of the device.

16. The device of claim 15, wherein the processor is further configured to:
send the browsing information of the user to a remote device.

17. The device of claim 10, wherein the processor is further configured to:
receive the browsing information about the selected contacts.

18. The device of claim 10, wherein the search request includes search terms.

19. A device comprising:
a processor configured to:
receive a search request and a list of contacts from a first remote device;
send the search request to a second remote device;
receive a search result from a second remote device;
filter the search result based on browsing information of the contacts; and
send the filtered search result to the first remote device.

20. A device comprising:
means for obtaining a search result from a search engine on behalf of a user;
means for filtering the search result based on browsing history information associated with contacts of the user; and
means for displaying the filtered search result.
